(19) United States
(12) Patent Application Publication
(10) Pub. No.: US 2024/0399323 A1
(43) Pub. Date: Dec. 5, 2024

(54) MIXING INSTALLATION WITH A DOSING DEVICE

(71) Applicant: SCHIPPERS EUROPE B.V., Hapert (NL)

(72) Inventors: Stijn Petrus Brigitta TAELMAN, Hapert (NL); Cornelis Wilhelmus VERSTIJNEN, Hapert (NL)

(21) Appl. No.: 18/699,757

(22) PCT Filed: Oct. 7, 2022
(86) PCT No.: PCT/NL2022/050566

§ 371 Date: Apr. 9, 2024

(30) Foreign Application Priority Data
Oct. 11, 2021 (NL) 2029377

(51) Int. Cl. B01F 25/312; B01F 35/00; B01F 101/24

(52) U.S. Cl. CPC B01F 25/31242; B01F 25/3125; B01F 35/188; B01F 2101/24

(57) ABSTRACT

A mixing installation is provided for mixing a first agent to a liquid. The mixing installation includes a dosing assembly and a first agent supply conduit. The dosing assembly includes a venturi arrangement and a first dosing device between the first agent supply conduit and the venturi arrangement. The first dosing device includes a first agent passage and a first dosing mandrel having a first dosing pin that extends in the first agent passage, wherein the first dosing mandrel is axially slidable in its axial direction with respect to the first main body over a first release stroke by pulling between a dosing position in which the first dosing pin extends inside the first agent passage to define a first ring shaped dosing channel around the first dosing pin, and a retracted position in which the first ring shaped dosing channel is cancelled.

### BACKGROUND

The invention relates to a mixing installation with a dosing assembly for dosing an agent to a liquid. The agent is for example a disinfectant that is added to a high pressure water flow, for example for cleaning or disinfecting animal stables or barns, for example cattle stables, pig stables or chicken barns.

A known mixing installation for dosing an agent to a water flow for that purpose comprises a high pressure water pump that feeds the water flow into a venturi assembly. The venturi causes an under pressure that draws the agent from an agent container into the passing water flow. The dosage is for example set by means of an internal choke pipe.

### SUMMARY OF THE INVENTION

A disadvantage of the known mixing installation is that the mixing installation is that in practice it works only very well with agents that are free of any particle containing dirt. When the agent accidentally contains some hard particles, for example sand that is present in an animal breeding environment, the choke pipe may become clogged. When this is not noticed by the operator, the water flow lacks the required disinfecting properties. The stable or barn may therefore not meet the prescribed sanitary requirements.

It is an object of the present invention to provide a mixing installation with a dosing assembly for dosing an agent to a liquid, that can be operated in animal stables or barns, for example cattle stables, pig stables or chicken barns.

According to a first aspect, the invention provides a mixing installation for mixing a first agent to a liquid, wherein the mixing installation comprises a liquid supply conduit, a mixture discharge conduit, a dosing assembly between the liquid supply conduit and the mixture discharge conduit, a first agent container, and a first agent supply conduit between the first agent container and the dosing assembly, wherein the dosing assembly comprises a venturi arrangement between the liquid supply conduit and the mixture discharge conduit, and a first dosing device between the first agent supply conduit and the venturi arrangement, wherein the first dosing device comprises a first main body with a first agent passage that is in fluid communication with the first agent supply conduit and the venturi arrangement, and a first dosing mandrel having a first dosing pin that extends in the first agent passage, wherein the first dosing mandrel is reciprocally slidable in its axial direction with respect to the first main body over a first release stroke between a dosing position in which the first dosing pin extends inside the first agent passage to define a first ring shaped dosing channel around the first dosing pin with a constant first radial flow height around the circumference of the first dosing pin, and a retracted release position in which the first ring shaped dosing channel is cancelled.

The mixing installation according to the invention comprises a first dosing device having a first ring shaped dosing channel with a defined first radial flow height around the circumference of the first dosing pin to set the feed of agent to the venturi arrangement with high accuracy. However, when the first agent contains some dirt, for example sand, it may get stuck and accumulate in front of or inside the first ring shaped dosing channel. The accumulated dirt can easily be released an removed by sliding the dosing mandrel from the dosing position into the retracted release position whereby the entire first agent passage is cancelled to allow the accumulated dirt to escape via the venturi assembly. This can be performed regularly to ensure a proper dosage of the first agent.

In an embodiment the first ring shaped dosing channel has the constant first radial height over the length of the first ring shaped dosing channel in the flow direction of the first agent passage, whereby the dosage can be set very accurately.

In an embodiment the first radial flow height is the smallest flow width as from the first agent container to the mixture discharge conduit, whereby it is guaranteed that the released dirt can escape via the venturi arrangement.

In an embodiment the first dosing device comprises a first spring that biases the first dosing mandrel over its entire first release stroke to the dosing position, whereby the first dosing pin can be pulled out of the first agent passage to release dirt, whereafter it can snap back to be ready for dosing again. This can be performed very quickly during the work in the stable environment, without having to take care of the dosage setting.

In an embodiment the first dosing device comprises a first linear slide bearing between the first main body and the first dosing mandrel for guiding the sliding movement of the first dosing mandrel with respect to the first main body over its first release stroke. A slide bearing allows the first dosing mandrel to slide with respect to the first main body while maintaining its orientation, that is without axial rotation.

In an embodiment the first dosing device comprises a first pull knob on the first dosing mandrel for manual pulling the first dosing mandrel into the retracted release position. The accumulated dirt can then very easily be removed by manually pulling on the first pull knob. This can be done for example when the first agent container is replaced.

In an embodiment the dosing assembly comprises a first check valve between the first dosing device and the venturi arrangement that prevents a backflow of the first agent from the venturi arrangement to the first dosing device.

In an embodiment the mixing installation comprises a first dirt filter before or inside the first agent supply conduit to prevent the entry of dirt having particles that are for example larger than that can pass the venturi arrangement. In this manner the entire flow path as from the first agent container to the mixture discharge conduit is protected against entry and accumulation of particles that cannot be released anymore by retraction of the first dosing mandrel.

In an embodiment the mixing installation comprises a container holder for insertion and holding the first agent container, whereby the first agent container can be embodied as a disposable or single use container, such as a jerrycan.

In an embodiment the mixing installation comprises a vertical support above the container holder, wherein the dosing assembly is vertically slidable along the vertical support between a low position in which the first agent supply conduit extends through a top opening of the first agent container, and a high position in which the first agent supply conduit is fully retracted from the first agent container. The vertical support can ensure that the inlet end of the first agent supply conduit remains free from a dirty floor.

In an embodiment the mixing installation comprises a second agent container and a second agent supply conduit between the second agent container and the dosing assembly, wherein the dosing assembly comprises a second dosing device between the second agent supply conduit and the venturi arrangement, wherein the second dosing device comprises a second main body with a second agent passage that is in fluid communication with the second agent supply conduit and the venturi arrangement, and a second dosing mandrel having a second dosing pin that extends in the second agent passage, wherein the second dosing mandrel is reciprocally slidable in its axial direction with respect to the second main body over a second release stroke between a dosing position in which the second dosing pin extends inside the second agent passage to define a second ring shaped dosing channel around the second dosing pin with a constant second radial flow height around the circumference of the second dosing pin, and a retracted release position in which the second ring shaped dosing channel is cancelled.

The mixing installation according to this embodiment is suitable for mixing two different agents to the liquid flow, for example a cleaning agent and a disinfection agent. The second dosing device may have the same features and advantages as the first dosing device.

In an embodiment thereof the second ring shaped dosing channel has the constant second radial height over the length of the second ring shaped dosing channel in the flow direction of the second agent passage.

In an embodiment the second radial flow height is the smallest flow width as from the second agent container to the mixture discharge conduit.

In an embodiment the second dosing device comprises a second spring that biases the second dosing mandrel over its entire second release stroke to the dosing position.

In an embodiment the second dosing device comprises a second linear slide bearing between the second main body and the second dosing mandrel for guiding the sliding movement of the second dosing mandrel with respect to the second main body over its second release stroke.

In an embodiment the second dosing device comprises a second pull knob on the second dosing mandrel for manual pulling the second dosing mandrel into the retracted release position.

In an embodiment the dosing assembly comprises a second check valve between the second dosing device and the venturi arrangement that prevents a backflow of the second agent from the venturi arrangement to the second dosing device.

In an embodiment the mixing installation comprises a second dirt filter before or inside the second agent supply conduit.

In an embodiment the mixing installation comprises a container holder for insertion and holding the first agent container and the second agent container, whereby both the first agent container and the second agent container can be embodied as a disposable or single use container, such as a jerrycan.

In an embodiment thereof the mixing installation comprises a vertical support above the container holder, wherein the dosing assembly is vertically slidable along the vertical support between a low position in which the first agent supply conduit and the second agent supply conduit extend through top openings of the first agent container and second agent container, and a high position in which the first agent supply conduit and the second agent supply conduit are fully retracted from the first agent container and the second agent container.

In an embodiment the mixing installation comprises a high pressure water pump that is connected with the liquid supply conduit.

In an embodiment the mixing installation comprises a high pressure water gun that is connected with the mixture discharge conduit for manually cleaning by means of the mixing installation according to the invention.

According to a second aspect, the invention provides a dosing assembly for use in a mixing installation according to the invention.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 is an isometric view of a mixing installation having a dosing assembly according to the invention;

FIGS. 2A-2C are an isometric view, a partial horizontal cross section and a partial vertical cross section of the dosing assembly of FIG. 1; and

FIGS. 3A and 3B are a partial cross section and a full cross section of a dosing device that forms part of the dosing assembly of FIGS. 2A-2C, in respectively a dosing position and a retracted position.

### DETAILED DESCRIPTION OF THE INVENTION

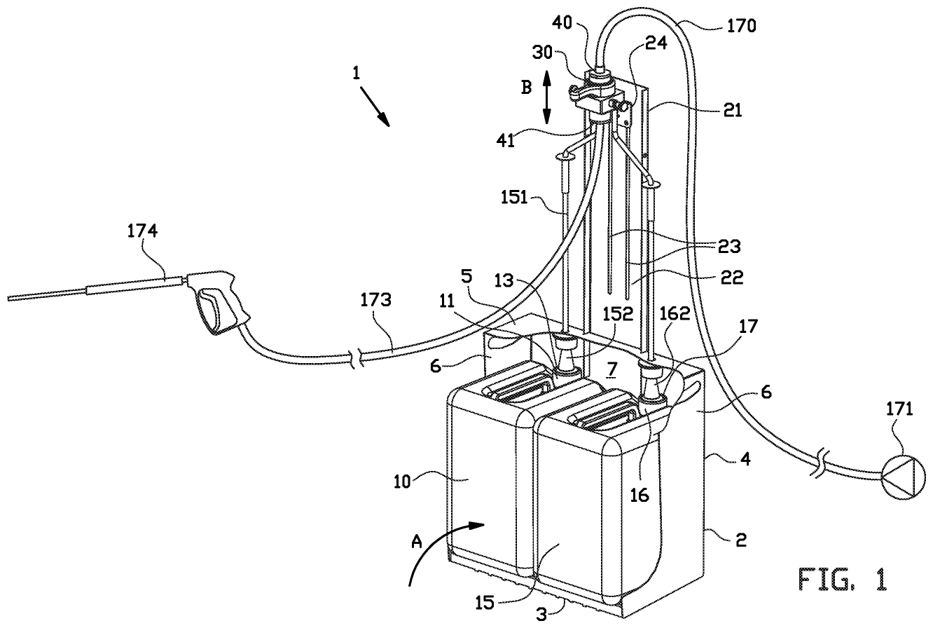

FIG. 1 shows a mixing installation 1 that comprises a metal container holder 2 with in this example a first agent container 10 that contains in this example a liquid cleaning agent, and a second agent container 15 that contains in this example a liquid disinfection agent. The container holder 2 comprises a bottom wall 3, a back wall 4, a top wall 5 that is partially cut out for illustration only, and two connecting side walls 6 that bound an insert opening 7 for insertion of the first agent container 10 and the second agent container 15 in direction A. The first agent container 10 and the second agent container 15 are both embodied as jerrycans, and comprise respectively a first screw connection 11 and a second screw connection 16 of which the screw caps have been removed for access via the respective first opening 13 and the second opening 17 inside the container holder 2. Alternatively, the first agent container 10 and the second agent container 15 comprise a closure that can be pierced or teared off for access to the contained agent.

The mixing installation 1 comprises a metal dosing assembly holder 21 having a vertical support 22 that is connected to the container holder 2. The dosing assembly holder 21 comprises a slider 24 that is slidable in a vertical direction B along two parallel elongated slots 23 in the vertical support 22. The mixing installation 1 comprises a dosing assembly 30 that is mounted on the slider 24.

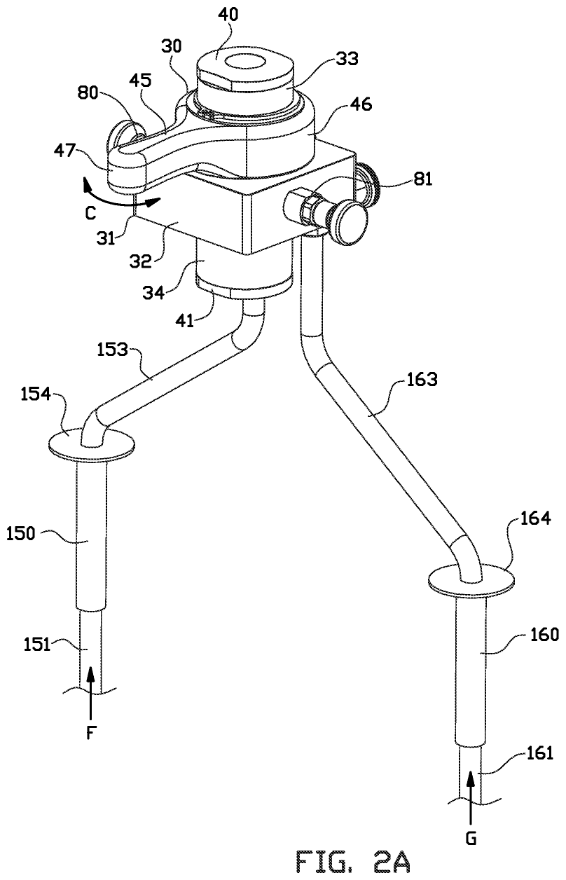

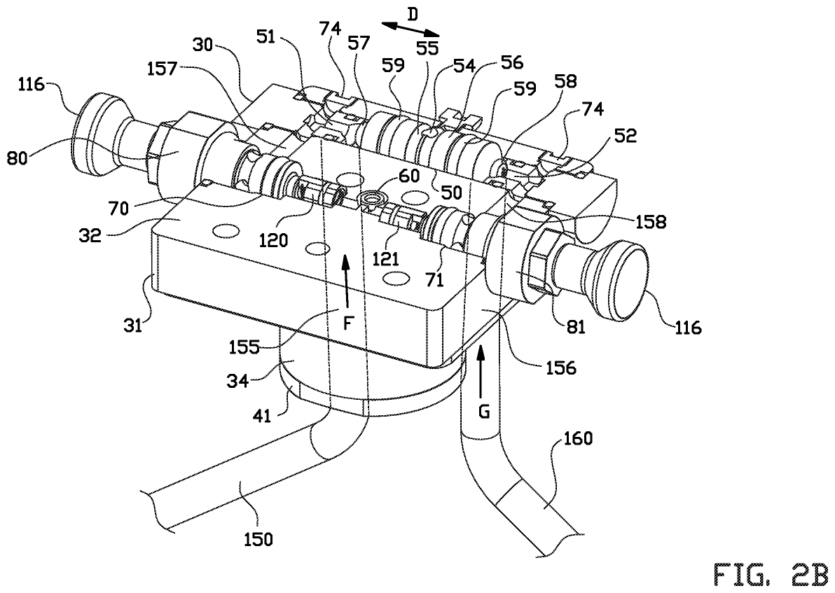

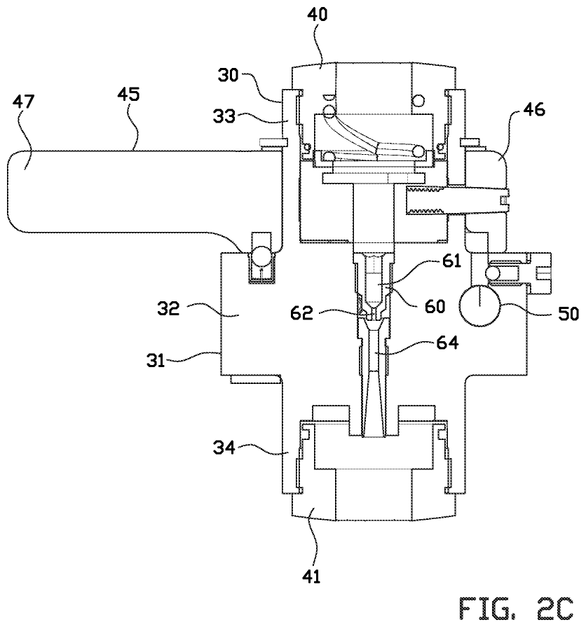

The dosing assembly 30 is shown in more detail in FIGS. 2A-2C, and comprises a metal casing 31 having a block-shaped casing base 32 that merges into a cylindrical fluid inlet section 33 in which an inlet connector 40 is screwed, and a cylindrical fluid outlet section 34 in which an outlet connector 41 is screwed. The dosing assembly 30 comprises a selection switch 45 having a ring section 46 that extends around the inlet section 33, and a handle 47 that projects from the casing base 32 and that can toggle in direction C with respect to the inlet section 33.

The dosing assembly 30 comprises a first agent supply conduit 150 for the first agent container 10 and a second agent supply conduit 160 for the second agent container 15 that are symmetrically shaped. The first agent supply conduit 150 is formed with a tube, and comprises a first straight section 151 that merges into a first transition section 153 that is mounted to the casing base 32. The first agent supply conduit 150 comprises a first inlet filter holder 152 on the end of the first straight section 151 in which a not-shown first dirt filter is enclosed, and a first stop 154 at the merger of the first straight section 151 and the first transition section 153. The second agent supply conduit 160 is formed with a tube, and comprises a second straight section 161 that merges into a second transition section 163 that is mounted to the casing base 32. The second agent supply conduit 160 comprises a second inlet filter holder 162 at the end of the second straight section 161 in which a not-shown second dirt filter is enclosed, and a second stop 164 at the merger of the second straight section 161 and the second transition section 163.

The first inlet filter holder 152 and the second inlet filter holder 162 are moveable in the vertical direction B by means of the slider 24 over a limited stroke between the fully retracted position as shown in FIG. 1 in which the first agent container 10 and the second agent container 15 can be placed into the container holder 2, and a fully lowered position in which the first stop 154 and the second stop 164 abut the top wall 5 whereby the first filter holder 152 and the second filter holder 162 are in contact with, or just a few millimeters spaced apart from the bottoms of the first agent container 10 and the second agent container 15.

As shown in FIG. 1, the inlet connector 40 is via a liquid supply conduit 170 connected with a high pressure water pump 171 that can supply water at a pressure of more than 100 bar, preferably more than 200 bar. In this example the outlet connector 41 is via a mixture discharge conduit 173 connected with a high pressure water gun 174. FIGS. 1 and 2A show the handle 47 in its neutral position in which the water passes without agent dosage. When the handle 47 is set in direction C from the neutral position into a first or left position the dosing assembly 30 doses agent from the first agent container 10 to the passing water, and when the handle 47 is set in direction C from the neutral position into a second or right position, the dosing assembly 30 doses agent from the second agent container 15 to the passing water, both at a precisely defined dedicated dosage or mixing ratio for each agent.

As shown in FIG. 2C the casing base 32 of the dosing assembly 30 encloses a venturi arrangement 60 between the inlet connector 40 and the outlet connector 41. The venturi arrangement 60 defines in series an inlet channel 61 that merges into a venturi nozzle 62, and a venturi channel 64 opposite to the venturi nozzle 62 that conically widens towards the outlet connector 41.

As best shown in FIG. 2B, the casing base 32 comprises a plunger channel 50 that at the ends merges into a first outlet channel 51 and a second outlet channel 52 with a smaller diameter than the plunger channel 50. The dosing assembly 30 comprises a switch plunger 55 that can slide through the plunger channel 50 in an axial sliding direction D between the first outlet channel 51 and the second outlet channel 52. The switch plunger 55 comprises an elongated plunger body 56 and a projecting notch 54 that is internally engaged by the selection switch 45. The plunger body 56 carries a first end seal 57 for sealing off the first outlet 51 and a second end seal 58 for scaling off the second outlet 52 depending on its position in the sliding direction D as set by the selection switch 45. The switching plunger 55 comprises two seals 59 around the plunger body 56 that seal off against the plunger channel 50.

The casing base 32 comprises a first inlet channel 155 that is connected to the first agent supply conduit 150 and that debouches between the first outlet channel 51 and the adjacent seal 59 of the switching plunger 55. The casing base 32 comprises a second inlet channel 156 that is connected to the second agent supply conduit 160 and that debouches between the second outlet channel 52 and the adjacent seal 59 of the switching plunger 55. The casing base 32 comprises a first intermediate channel 157 that extends between the first outlet 51 and a first insert channel 70, and a second intermediate channel 158 that extends between the second outlet 52 and a second insert channel 71. The first insert channel 70 and the second insert channel 72 both debouche aside the venturi nozzle 62 and are in fluid communication therewith.

In this example the plunger channel 50 is a blind bore in the casing base 32 that is at one side closed by an screw cap 53 that comprises the first outlet channel 51 and a part of the first intermediate channel 157. The first intermediate channel 157 and the second intermediate channel 158 are blind bores that are closed off by screws 74. The first insert channel 70 and the second insert channel 70 are stepped bores in the casing base 32.

The casing 31 comprises a not-shown venturi bypass channel for bypassing the venturi arrangement 60, and a closing arrangement for the venturi bypass channel that is operated by the selection switch 45. The closing arrangement closes off the venturi bypass channel in the first and second position of the handle 47, and opens the venturi bypass channel when the handle 47 is in its neutral position as shown in FIGS. 1 and 2A.

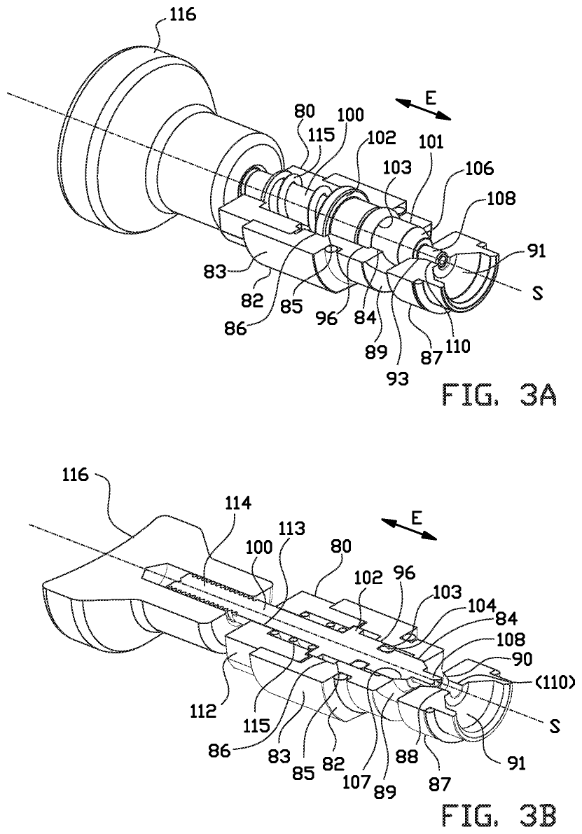

The dosing assembly 30 comprises a first dosing device 80 and a first check valve 120 in series therewith that are inserted in the first insert channel 70, and a second dosing device 81 and a second check valve 121 in series therewith that are inserted in the second insert channel 71. The first dosing device 80 and the second dosing device 81 are identical and are therefore described hereafter under reference to the first dosing device 80 as shown in FIGS. 3A and 3B.

The first dosing device 80 has a main body 82 that comprises a proximal side 83 with an internal cylindrical bearing passage 84 that merges via a first cylindrical guide chamber 93 and a widening abutment edge 85 into a wider cylindrical guide chamber 86. The main body 82 comprises a distal end 87 with an internal cylindrical agent passage 88. The bearing passage 84 and the agent passage 88 are aligned on the center line S of the first dosing device 80. The main body 82 comprises a ring-shaped inlet 89 that is in fluid connection with the end of the first intermediate channel 157. The ring-shaped inlet 89 merges via an internal conical wall 90 into the agent passage 88. The agent passage 88 merges into an outlet 91 of the distal end 87 of the main body 82.

The first dosing device 80 comprises a dosing mandrel 100 inside the main body 82. The dosing mandrel 100 comprises a cylindrical bearing section 101 that extends through the bearing passage 84 to guide a sliding reciprocal movement of the dosing mandrel 100 in direction E, and a radially projecting collar 102 inside the guide chamber 86 that can come in abutment with the abutment edge 85. The dosing mandrel 100 comprises a seal chamber 103 in which a seal 104 is enclosed to seal off against the wall of the first cylindrical guide chamber 93. The dosing mandrel 100 comprises a distal end 106 that is bound by an external conical wall 107 that extends around its circumference parallel to the internal conical wall 90 of the main body 82. The external conical wall 107 merges into a cylindrical dosing pin 108. When the dosing mandrel 100 is in its dosing position as shown in FIG. 3A, the collar 102 is in abutment with the abutment edge 85 and the dosing pin 82 extends centered through the agent passage 88 to define a ring shaped dosing channel 110 around the dosing pin 82 with a constant radial flow height around the circumference of the ring shaped dosing channel 110 and a constant radial flow height over the axial length of the ring shaped dosing channel 110.

The first dosing device 80 comprises a screw cap 112 with a passage 113 for the dosing mandrel 100. The screw cap 112 confines a push spring 115 that biases the dosing mandrel 100 via the collar 102 to its dosing position. The dosing mandrel 100 comprises a threaded end 114 to which a pull knob 116 is mounted by which the dosing mandrel 100 can be pulled in direction E against the bias of the push spring 115 to a temporal retracted release position in which the dosing pin 82 is fully retracted from the agent passage 88 whereby the ring shaped dosing channel 110 is temporally cancelled.

When during the operation of the pump 171 the handle 47 is in its neutral position, the pressurized water bypasses the venturi arrangement 60 whereby it is not active. When the handle 47 is in the selected first position or second position, the venturi bypass channel is closed, whereby the venturi nozzle 62 and the venturi channel 64 together cause an under pressure. The selected agent is sucked in via the first dirt filter or the second dirt filter and subsequently passes in the respective flow direction F, G the ring-shaped inlet 89 and the ring shaped dosing channel 110 of the respective first dosing device 80 or second dosing device 81 to enter the common venturi channel 64 via the respective first check valve 120 or second check valve 121. In these flow paths the first dirt filter and the second dirt filter prevent entry of debris having a particle size that is larger than the cross section of the venturi nozzle 62 or that is larger than the smallest passage of the high pressure water gun 174.

The ring shaped dosing channels 110 have a radial height or smallest flow width in the radial direction and the axial direction that is smaller than the cross section of the venturi nozzle 62, which is necessary to obtain the precisely defined dosage or mixing ratio for each agent. The smaller particles of the debris that has passed the first dirt filter or the second dirt filter passes the ring shaped dosing channels 110, while the larger particles may stick and accumulate at the entrance of the ring shaped dosing channels 110. These accumulated particles can be released regularly by pulling on the knob 116, whereby the dosing mandrel 100 is brought into its temporal retracted release position in which the dosing pin 108 is outside the agent passage 88 to release and flush away the accumulated particles via the venturi channel 64.

The mixing installation 1 is very suitable to be used in animal stables or barns, for example cattle stables, pig stables or chicken barns that are regularly cleaned and disinfected by means of the high pressure water gun 174. In those environments it is inevitable that some debris enters mixing installation 1, for example during exchange of the agent containers 10, 15, or because the agents in the agent containers 10, 15 is slightly polluted by sand for example which does not adversely affect the quality of the contained agent. The debris remains behind the first dirt filter or the second debris filter, or it is regularly released from the ring shaped dosing channels 110 to exit the mixing installation 1 via the venturi assembly 60 and the high pressure water gun 174. As accumulated dirt in front of the ring shaped dosing channels 110 is regularly released, a practically constant correct dosage of the agent to the water flow is guaranteed.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-24. (canceled)

25. A mixing installation for mixing a first agent to a liquid, wherein the mixing installation comprises a liquid supply conduit, a mixture discharge conduit, a dosing assembly between the liquid supply conduit and the mixture discharge conduit, a first agent container, and a first agent supply conduit between the first agent container and the dosing assembly,
wherein the dosing assembly comprises a venturi arrangement between the liquid supply conduit and the mixture discharge conduit, and a first dosing device between the first agent supply conduit and the venturi arrangement,
wherein the first dosing device comprises a first main body with a first agent passage that is in fluid communication with the first agent supply conduit and the venturi arrangement, and a first dosing mandrel having a first dosing pin that extends in the first agent passage,
wherein the first dosing mandrel is reciprocally slidable in its axial direction with respect to the first main body over a first release stroke by pulling between a dosing position in which the first dosing pin extends inside the first agent passage to define a first ring shaped dosing channel around the first dosing pin with a constant first radial flow height around the circumference of the first dosing pin, and a retracted release position in which the first dosing pin is fully retracted from the first agent passage and the first ring shaped dosing channel is cancelled.

26. The mixing installation according to claim 25, wherein the first ring shaped dosing channel has the constant first radial height over the length of the first ring shaped dosing channel in the flow direction of the first agent passage.

27. The mixing installation according to claim 25, wherein the first radial flow height is the smallest flow width as from the first agent container to the mixture discharge conduit.

28. The mixing installation according to claim 25, wherein the first dosing device comprises a first spring that biases the first dosing mandrel over its entire first release stroke to the dosing position.

29. The mixing installation according to claim 25, wherein the first dosing device comprises a first linear slide bearing between the first main body and the first dosing mandrel for guiding the sliding movement of the first dosing mandrel with respect to the first main body over its first release stroke.

30. The mixing installation according to claim 25, wherein the first dosing device comprises a first pull knob on the first dosing mandrel for manual pulling the first dosing mandrel into the retracted release position.

31. The mixing installation according to claim 25, wherein the dosing assembly comprises a first check valve between the first dosing device and the venturi arrangement that prevents a backflow of the first agent from the venturi arrangement to the first dosing device.

32. The mixing installation according to claim 25, comprising a first dirt filter before or inside the first agent supply conduit.

33. The mixing installation according to claim 25, comprising a container holder for insertion and holding the first agent container, and a vertical support above the container holder,
wherein the dosing assembly is vertically slidable along the vertical support between a low position in which the first agent supply conduit extends through a top opening of the first agent container, and a high position in which the first agent supply conduit is fully retracted from the first agent container.

34. The mixing installation according to claim 25, comprising a second agent container and a second agent supply conduit between the second agent container and the dosing assembly,
wherein the dosing assembly comprises a second dosing device between the second agent supply conduit and the venturi arrangement,
wherein the second dosing device comprises a second main body with a second agent passage that is in fluid communication with the second agent supply conduit and the venturi arrangement, and a second dosing mandrel having a second dosing pin that extends in the second agent passage,
wherein the second dosing mandrel is reciprocally slidable in its axial direction with respect to the second main body over a second release stroke by pulling between a dosing position in which the second dosing pin extends inside the second agent passage to define a second ring shaped dosing channel around the second dosing pin with a constant second radial flow height around the circumference of the second dosing pin, and a retracted release position in which the second dosing pin is fully retracted from the second agent passage and the second ring shaped dosing channel is cancelled.

35. The mixing installation according to claim 34, wherein the second ring shaped dosing channel has the constant second radial height over the length of the second ring shaped dosing channel in the flow direction of the second agent passage.

36. The mixing installation according to claim 34, wherein the second radial flow height is the smallest flow width as from the second agent container to the mixture discharge conduit.

37. The mixing installation according to claim 34, wherein the second dosing device comprises a second spring that biases the second dosing mandrel over its entire second release stroke to the dosing position.

38. The mixing installation according to claim 34, wherein the second dosing device comprises a second linear slide bearing between the second main body and the second dosing mandrel for guiding the sliding movement of the second dosing mandrel with respect to the second main body over its second release stroke.

39. The mixing installation according to claim 34, wherein the second dosing device comprises a second pull knob on the second dosing mandrel for manual pulling the second dosing mandrel into the retracted release position.

40. The mixing installation according to claim 34, wherein the dosing assembly comprises a second check valve between the second dosing device and the venturi arrangement that prevents a backflow of the second agent from the venturi arrangement to the second dosing device.

41. The mixing installation according to claim 34, comprising a second dirt filter before or inside the second agent supply conduit.

42. The mixing installation according to claim 34, comprising a container holder for insertion and holding the first agent container and the second agent container, and a vertical support above the container holder,
wherein the dosing assembly is vertically slidable along the vertical support between a low position in which the first agent supply conduit and the second agent supply conduit extend through top openings of the first agent container and second agent container, and a high position in which the first agent supply conduit and the second agent supply conduit are fully retracted from the first agent container and the second agent container.

43. The mixing installation according to claim 25, comprising a high pressure water pump that is connected with the liquid supply conduit.

44. A dosing assembly for use in a mixing installation according to claim 25.
